(19) United States
(12) Patent Application Publication
(10) Pub. No.: US 2024/0351087 A1
(43) Pub. Date: Oct. 24, 2024

(54) Impact Hydroforming Mold and Impact Hydroforming Method with Integration of Blank Holder and Feeding

(71) Applicant: Institute of Metal Reseach Chinese Academy of Sciences, Shenyang (CN)

(72) Inventors: Yong XU, Shenyang (CN); Shihong Zhang, Shenyang (CN); Liangliang Xia, Shenyang (CN); Wenlong Xie, Shenyang (CN); Hao Li, Shenyang (CN); Hongliang Zhu, Shenyang (CN); Xingyu Duan, Shenyang (CN)

(21) Appl. No.: 18/639,411

(22) Filed: Apr. 18, 2024

(30) Foreign Application Priority Data
Apr. 18, 2023 (CN) 202310414051.8

(51) Int. Cl. B21D 22/20; B21D 24/08

(52) U.S. Cl. CPC B21D 22/205; B21D 24/08

(57) ABSTRACT

The present disclosure provides an impact hydroforming mold and an impact hydroforming method with integration of blank holder and feeding, belonging to the technical field of metal forming. The hydroforming mold includes: a lower concave mold, a blank holder ring, and a working sleeve assembly. A working sleeve has a liquid chamber for containing liquid medium and a stamping acceleration channel; a throttling flow channel is formed between working sleeve and blank holder ring; the liquid medium can be throttled and depressurized through the throttling flow channel and then contacted with side face of the sheet. Under the action of intensity of pressure, the edge of the sheet pressed by the blank holder ring can be allowed in a mutually adaptive way to realize feeding in a downward forming process when the middle area of the sheet suffers impact, so forming quality of a target component can be effectively improved.

### CROSS-REFERENCE TO RELATED APPLICATION

This application claims priority from the Chinese patent application 202310414051.8 filed Apr. 18, 2023, the content of which is incorporated herein in the entirety by reference.

### TECHNICAL FIELD

The present disclosure belongs to the technical field of metal forming, and in particular relates to an impact hydroforming mold and an impact hydroforming method with integration of blank holder and feeding.

### BACKGROUND ART

In a traditional sheet stamping technique, multi-pass and multi-process forming methods are often used. For forming with large deformation features, multi-pass deep drawing is needed which are involved problems of lateral feeding and blank holder force. At present, in order to realize the technique of feeding, blank holder and forming, it is necessary to adopt a special mold for multi-pass forming. This manufacturing method not only has high cost and low forming efficiency, but also leads to low dimensional accuracy of final parts and poor reliability of parts due to accumulated errors between each pass and each process.

An impact hydroforming technology can form an integrated sheet part by only one set of molds. The sheet parts can be formed by applying impact energy, mold constraints and a suitable velocity of rigid impactor. However, existing impact hydroforming molds lack related structural design of integration of blank holder and feeding, which leads to high manufacture cost, low efficiency and poor quality of target components, and a phenomenon of wrinkling of the sheet in the forming process.

### SUMMARY

Therefore, the present disclosure provides an impact hydroforming mold and an impact hydroforming method with integration of blank holder and feeding, which can solve the technical problem that impact hydroforming molds in the prior art lack related structural design of sheet blank holder and feeding, which leads to high manufacture cost, low efficiency and poor quality of target components, and a phenomenon of wrinkling of the sheet in the forming process.

In order to solve the above problems, the present disclosure provides an impact hydroforming mold with integration of blank holder and feeding, including:
a lower concave mold, which is provided with a forming mold cavity, wherein the shape of the forming mold cavity is matched with the shape of a target component;
a blank holder ring, which is placed on a sheet to form pressing on the sheet during a forming operation of the mold, wherein the blank holder ring is provided with a central hole corresponding to the position of a cavity opening of the forming mold cavity;
a working sleeve assembly, which is sleeved on the radial outer side of the blank holder ring and is hermetically connected to a first end face of the lower concave mold, wherein the working sleeve assembly includes a working sleeve; the working sleeve has a liquid chamber for containing a liquid medium and a stamping acceleration channel for guiding linear movement of a rigid impactor; a throttling flow channel is formed between one end of the working sleeve facing the lower concave mold and one end of the blank holder ring facing the working sleeve; and the liquid medium in the liquid chamber can be throttled and depressurized through the throttling flow channel and then contacted with a thickness side face of the sheet.

In some embodiments, the end of the working sleeve facing the lower concave mold is a first conical face; the end of the blank holder ring facing the working sleeve is a second conical face; the taper of the first conical face is equal to that of the second conical face.

In some embodiments, the first conical face is provided with a first flow control structure extending along a circumferential direction; the second conical face is provided with a second flow control structure extending along a circumferential direction; and the first flow control structure and the second flow control structure are relatively spaced apart to form a throttling annular gap for the liquid medium.

In some embodiments, the cross-sectional shapes of the first flow control structure and the second flow control structure are semicircular on the axial section of the working sleeve.

In some embodiments, the working sleeve assembly further includes a fixed sleeve which is hermetically sleeved on the end of the working sleeve facing the lower concave mold; and the working sleeve assembly is hermetically connected to the lower concave mold by means of the fixed sleeve.

In some embodiments, a positioning convex ring protruding towards one side of the working sleeve is formed at a cavity opening of the forming mold cavity; the positioning convex ring is sleeved with a positioning ring; floating space is formed between the positioning ring and the first end face; and the liquid medium in the liquid chamber can enter the floating space through the throttling flow channel.

In some embodiments, friction coefficients of the blank holder ring and the positioning ring are the same as μ. During a mold forming operation, the surface area of the thickness side face of the sheet is S1; the intensity of pressure of the liquid medium in the liquid chamber is P0; the intensity of pressure of the liquid medium throttled through the throttling flow channel is P1; the surface area of the second conical face close to the liquid chamber at the side of the second flow control structure is S2; the surface area far from the liquid chamber at the side of the second flow control structure is S3; a taper angle of the second conical face is α; and the surface area of the side facing away from the blank holder ring of the positioning ring is S4, where P1·S1−μ((P0·S2+P1·S3)cos α+P1·S4)>0, and P1<P0.

In some embodiments, the friction coefficient of the blank holder ring is μ. During a mold forming operation, the surface area of the thickness side face of the sheet is S1; the intensity of pressure of the liquid medium in the liquid chamber is P0; the intensity of pressure of the liquid medium throttled through the throttling flow channel is P1; the surface area of the second conical face close to the liquid chamber at the side of the second flow control structure is S2; the surface area far from the liquid chamber at the side of the second flow control structure is S3; and a taper angle of the second conical face is a, where P1·S1−μ(P0·S2+P1·S3)cos α>0, and P1<P0.

The present disclosure further provides an impact hydroforming method of a sheet, which is carried out by adopting the impact hydroforming mold with integration of blank holder and feeding, and includes the following steps of:
fixing the lower concave mold on a base;
placing the sheet on the lower concave mold and covering the forming mold cavity;
placing the blank holder ring on the sheet;
assembling the working sleeve assembly on the lower concave mold;
filling the liquid medium into the liquid chamber; and
controlling the rigid impactor to descend to impact the liquid medium at a preset pressure.

The present disclosure further provides an impact hydroforming method of a sheet, which is carried out by adopting the impact hydroforming mold, and includes the following steps of:
fixing the lower concave mold on a base;
sleeving the positioning ring on the positioning convex ring;
placing the sheet on the positioning ring and covering the cavity opening of the forming mold cavity;
placing the blank holder ring on the side of the sheet which is far from the lower concave mold;
assembling the working sleeve assembly on the lower concave mold;
filling the liquid medium into the liquid chamber; and
controlling the rigid impactor to descend to impact the liquid medium at a preset pressure.

According to the impact hydroforming mold and the impact hydroforming method with integration of blank holder and feeding provided by the present disclosure, the liquid medium in the liquid chamber is guided into the thickness side face position of the sheet, so that hydraulic force can be applied to the sheet in the radial direction during impact hydroforming of the sheet. Meanwhile, the liquid medium in the throttling flow channel applies vertical component force facing the sheet to the blank holder ring. The hydraulic force and the vertical component force can in a mutually adaptive way allow the edge of the sheet pressed by the blank holder ring to realize feeding in a downward forming process when the middle area of the sheet suffers impact, which can effectively improve forming quality of the target component, reduce to a certain extent or even eliminate a wrinkling phenomenon of the sheet in the forming process. Without multi-pass and multi-process operations in a traditional forming process, manufacture cost of the target component can be reduced; and the forming efficiency can be improved.

### BRIEF DESCRIPTION OF THE DRAWINGS

FIG. 1 is a schematic structural diagram (axial section) of an impact hydroforming mold with integration of blank holder and feeding according to an embodiment of the present disclosure;

FIG. 2 is a schematic diagram of a stress state of related components of the mold in FIG. 1 during a sheet forming process;

FIG. 3 is a schematic structural diagram (axial section) of an impact hydroforming mold with integration of blank holder and feeding according to another embodiment of the present disclosure; and

FIG. 4 is a schematic diagram of a stress state of related components of the mold in FIG. 2 during a sheet forming process.

Marks in drawings are as follows:

1. lower concave mold; 11. forming mold cavity; 12. positioning convex ring; 2. blank holder ring; 21. central hole; 22. second flow control structure; 3. working sleeve; 31. liquid chamber; 32. stamping acceleration channel; 33. first flow control structure; 34. exhaust hole; 4. throttling flow channel; 5. fixed sleeve; 6. positioning ring; 7. base; 8. rigid impactor; and 100. sheet.

### DETAILED DESCRIPTION OF THE DISCLOSURE

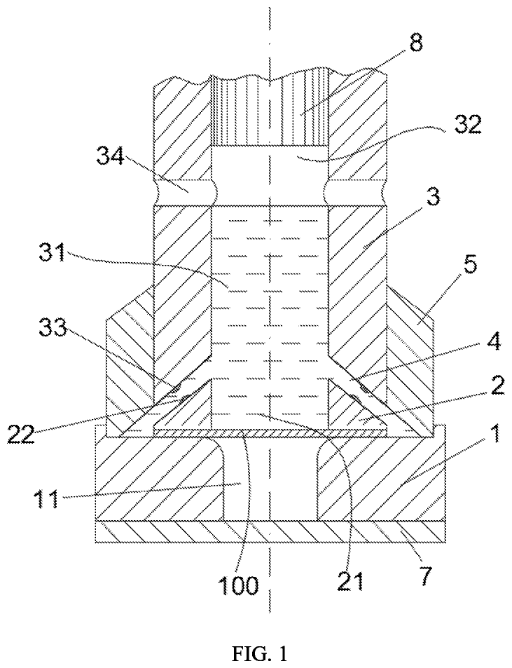

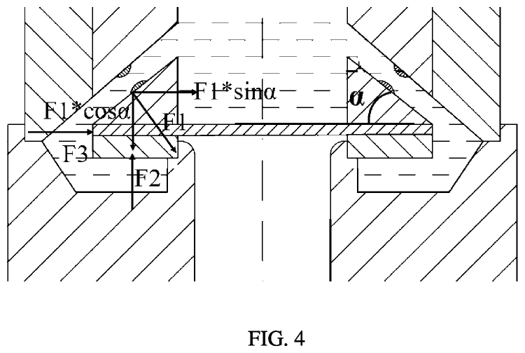

With reference to FIG. 1 to FIG. 4, according to embodiments of the present disclosure, an impact hydroforming mold with integration of blank holder and feeding is provided. Specifically, as shown in FIG. 1, the impact hydroforming mold with integration of blank holder and feeding includes:
a lower concave mold 1, which is provided with a forming mold cavity 11, wherein the shape of the forming mold cavity 11 is matched with the shape of a target component; and the shape of the target component is the shape of a sheet 100 to be finally processed and formed;
a blank holder ring 2, which is placed on the sheet 100 to form pressing on the sheet 100 during a forming operation of the mold, wherein the blank holder ring 2 is provided with a central hole 21; the central hole 21 is corresponding to the position of a cavity opening of the forming mold cavity 11; and the central hole 21 enables impact to be applied to the sheet 100 to achieve a forming purpose of the sheet 100;
a working sleeve assembly (not marked in the figure), which is sleeved on the radial outer side of the blank holder ring 2 and is hermetically connected to a first end face of the lower concave mold 1 (in the range shown in FIG. 1, the first end face is the top end face of the lower concave mold 1). For example, the hermetical connection can be realized by arranging a sealing ring and other structures at a matching position therebetween. The working sleeve assembly includes a working sleeve 3; and the working sleeve 3 has a liquid chamber 31 for containing a liquid medium and a stamping acceleration channel 32 for guiding linear movement of a rigid impactor 8 (driven by a stamping device, not shown in the figure). See the range shown in FIG. 1 or FIG. 3, the stamping acceleration channel 32 and the liquid chamber 31 are arranged in sequence along a downstroke direction of the rigid impactor 8. Corresponding exhaust holes 34 are formed in the working sleeve 3 at the position where they meet, so as to prevent that downward impact of the rigid impactor 8 from directly contacting with the liquid surface, and ensure efficient force transmission. A throttling flow channel 4 is formed between one end (which can be understood as the bottom end) of the work sleeve 3 facing the lower concave mold land one end (which can be understood as the top end) of the blank holder ring 2 facing the working sleeve 3, which can realize throttling and depressurization of a liquid medium flowing through the same. In this way, the liquid medium in the liquid chamber 31 can be throttled and depressurized through the throttling flow channel 4 and then contacted with a thickness side face of the sheet 100. Therefore, the depressurized liquid medium can apply push force from the edge to the middle to the sheet 100, which is beneficial to feeding of the sheet 100. The above-mentioned thickness side face is the side elevation where the thickness of the sheet 100 is located, which can also be understood as the peripheral wall face (excluding the upper and lower top faces) of the sheet 100.

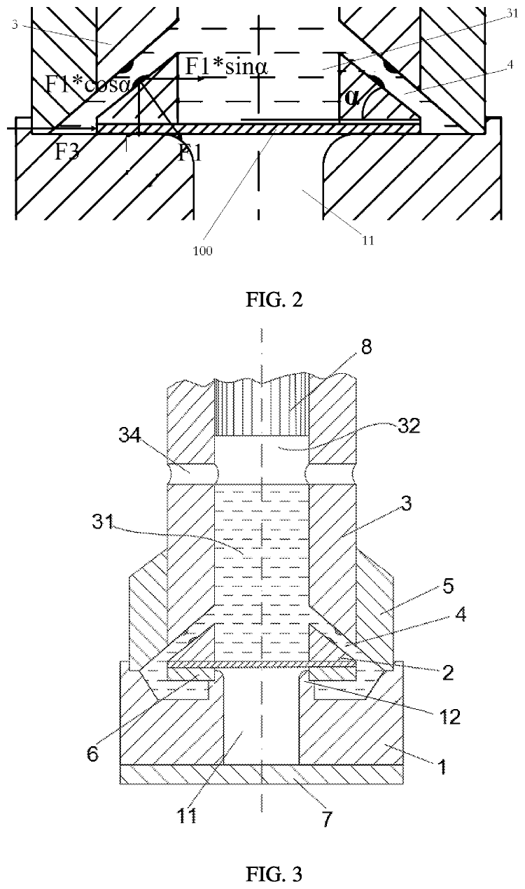

In the technical solution, unlike an impact hydroforming mold in the prior art, in the present application, the liquid medium in the liquid chamber 31 is guided into the thickness side face position of the sheet 100, so that hydraulic force can be applied to the sheet 100 in the radial direction during the impact hydroforming process of the sheet 100 (as shown by F3 in FIG. 2 and FIG. 4). Meanwhile, the liquid medium in the throttling flow channel 4 applies vertical component force (e.g. F1*cos α in FIG. 2 and FIG. 4) facing the sheet 100 to the blank holder ring 2. Under the action of different intensities of pressure of the liquid medium, the hydraulic force and the vertical component force can in a mutually adaptive way allow the edge of the sheet 100 pressed by the blank holder ring 2 to realize feeding in a downward forming process when the middle area of the sheet 100 suffers impact, which can effectively improve forming quality of the target component. Because the present disclosure can realize synchronous feeding of the sheet from the pressing edge to a deformation area in the forming process of the sheet, it can reduce to a certain extent or even eliminate a wrinkling phenomenon of the sheet in the forming process. Without multi-pass and multi-process operations in a traditional forming process, manufacture cost of the target component can be reduced; and the forming efficiency can be improved.

In some embodiments, the end of the working sleeve 3 facing the lower concave mold 1 is a first conical face; the end of the blank holder ring 2 facing the working sleeve 3 is a second conical face; and a taper of the first conical face is equal to that of the second conical face. Specifically, the bottom faces of the first conical face and the second conical face face the side where the lower concave mold 1 is located. A flow channel formed between the two conical faces is the above-mentioned throttling flow channel. In other words, there is no physical connection relation between the working sleeve 3 and the blank holder ring 2 objectively, which are independent of each other. The matching position there of forms an annular gap, which is the above-mentioned throttling flow channel. Hence, pressing force of the blank holder ring 2 on the sheet 100 can be controlled and adjusted according to the intensity of pressure of the liquid medium in the liquid chamber 31. Then control of a feeding amount and a feeding speed of the sheet 100 can be realized.

In a preferred embodiment, the first conical face is provided with a first flow control structure 33 extending along a circumferential direction; the second conical face is provided with a second flow control structure 22 extending along a circumferential direction; and the first flow control structure 33 and the second flow control structure 22 are relatively spaced apart to form a throttling annular gap (a gap with an annular shape) for the liquid medium. In other words, the first flow control structure 33 and the second flow control structure 22 are disposed in the throttling flow channel 4. A through flow area of the throttling annular gap can be adjusted by mutual sizes of the first flow control structure 33 and the second flow control structure 22, so that the pressure of the liquid medium, in the liquid chamber 31, which enters the area where the thickness side face of the sheet 100 is located can be adjusted. It is beneficial to adjusting the feeding amount and controlling the speed of the sheet 100. For example, the first flow control structure 33 and the second flow control structure 22 can be integrally formed with the working sleeve 3 and the blank holder ring 2 respectively. At this time, corresponding components with flow control structures with different sizes can be replaced when adjustment and depressurization are needed. As a further preferred implementation, the first flow control structure 33 and the second flow control structure 22 are detachably connected to the corresponding conical faces. At this time, in need of adjustment of the throttling and depressurization effect, it is only necessary to replace the flow control structures with different sizes, so the mold manufacture cost can be effectively reduced. In a specific embodiment, on the axial section of the working sleeve 3, the cross-sectional shapes of the first flow control structure 33 and the second flow control structure 22 are semicircular. At this time, the radius of the flow control structure can be changed to achieve different depressurization effects, which simplifies design and manufacturing difficulty of the flow control structure. It should be noted in particular that the throttling flow channel 4 in the present disclosure is disposed obliquely downward from the liquid chamber 31, which can ensure smooth flowing of the liquid medium.

The working sleeve assembly further includes a fixed sleeve 5. The fixed sleeve 5 is hermetically sleeved on the end of the working sleeve 3 facing the lower concave mold 1, and can form reliable support for the working sleeve 3. The working sleeve assembly is hermetically connected to the lower concave mold 1 by means of the fixed sleeve 5; and the lower concave mold 1 is fixedly connected to a base 7. In this way, the above-mentioned fixed sleeve 5, working sleeve 3 and lower concave mold 1 are formed into a stable whole in the forming process of the sheet. The fixed sleeve 5 and the working sleeve 3 can be detachably connected by threaded connection; and the fixed sleeve 5 and the lower concave mold 1 can be connected by inserting and die assembly. Meanwhile, corresponding sealing rings can be added to further realize sealing, so as to prevent the liquid medium from leaking from the mating gap.

In another specific embodiment, as shown in FIG. 3 and FIG. 4, a positioning convex ring 12 protruding towards one side of the working sleeve 3 is formed at a cavity opening of the forming mold cavity 11; the positioning convex ring 12 is sleeved with a positioning ring 6; floating space is formed between the positioning ring 6 and the first end face; and the liquid medium in the liquid chamber 31 can enter the floating space through the throttling flow channel 4. It can be understood that fitting and matching between the positioning convex ring 12 and the positioning ring 6 should ensure that a fitting gap therebetween is of a hermetical state on the premise that the positioning ring 6 can float up and down in a certain range, so as to prevent the liquid medium from circulating at the fitting gap therebetween. The hermetical connection therebetween can be realized by sealing with grease and the like. Different from the embodiment shown in FIG. 1, the depressurized liquid medium in the technical solution can not only apply push force to the thickness side face of the sheet 100 to achieve the purpose of feeding, but can also enter the floating space to apply vertical upward supporting force during the forming process of the sheet 100. The supporting force can be adjusted by means of the pressure, so that the forming quality of the target component can be further improved. As shown in FIG. 4, vertically upward F2 plays an objective role in floating the positioning ring 6 upward. When F2 is large, the upward force lifts the sheet 100 and the positioning ring 6 upward; and then forming time of the sheet 100 in the forming process becomes longer. Meanwhile, the contact range between the sheet 100 and a circular chamfer of the lower concave mold (that is, the edge position of a top hole of the inner hole of the positioning convex ring 12) becomes larger, so that feeding time will be correspondingly longer, which can improve the forming quality of the sheet 100.

Generally speaking, specific manufacture materials of the blank holder ring 2, the positioning ring 6 and the lower concave mold 1 will be the same. Of course, in some cases, different materials can also be selected. In order to facilitate control of feeding, a preferred solution is that the blank holder ring 2, the positioning ring 6 and the lower concave mold 1 are all made of the same material. At this time, they have the same friction coefficient, which is μ.

As shown in FIG. 4, during a mold forming operation, the surface area of the thickness side face of the sheet 100 is S1; the intensity of pressure of the liquid medium in the liquid chamber 31 is P0; the intensity of pressure of the liquid medium throttled through the throttling flow channel 4 is P1; the surface area of the second conical face at the side of the second flow control structure 22 close to the liquid chamber 31 is S2; the surface area at the side of the second flow control structure 22 far from the liquid chamber 31 is S3; a taper angle of the second conical face is α; and the surface area of the side of the positioning ring 6 facing away from the blank holder ring 2 is S4, where P1·S1−μ((P0·S2+P1·S3)cos α+P1·S4)>0, and P1<P0. It can be understood that, in the figure, F3=P1·S1; F2=P1·S4; and F1=P0·S2+P1·S3, which can ensure the feeding effect during the forming process of the sheet 100. In this way, after the mold is determined, adjustment of P0 can be realized by adjusting the impact force borne by the liquid medium. It can be understood that the above-mentioned P0 can be specifically obtained by the implementation, which is not repeated here.

As shown in FIG. 2, during a mold forming operation, the surface area of the thickness side face of the sheet 100 is S1; the intensity of pressure of the liquid medium in the liquid chamber 31 is P0; the intensity of pressure of the liquid medium throttled through the throttling flow channel 4 is P1; the surface area of the second conical face at the side of the second flow control structure 22 close to the liquid chamber 31 is S2; the surface area at the side of the second flow control structure 22 far from the liquid chamber 31 is S3; and a taper angle of the second conical face is α, where P1·S1−μ(P0·S2+P1·S3)cos α>0, and P1<P0.

According to an embodiment of the present disclosure, an impact hydroforming method of a sheet is further provided, which is carried out by adopting the impact hydroforming mold with integration of blank holder and feeding shown in FIG. 1, and includes the following steps of:
fixing the lower concave mold 1 on a base 7;
placing the sheet 100 on the lower concave mold 1 and covering the cavity opening of the forming mold cavity 11;
placing the blank holder ring 2 on the side of the sheet 100 far from the lower concave mold 1;
assembling the working sleeve assembly on the lower concave mold 1;
filling the liquid medium into the liquid chamber 31; and
controlling the rigid impactor 8 to descend to impact the liquid medium at a preset pressure. The impact of the rigid impactor 8 on the liquid medium forms a pressure wave conducted downward in the liquid medium, which is further applied to the middle position of the sheet 100 (the part of the sheet 100 at the position of the cavity opening of the forming mold cavity 11). Under the action of the impact force, the side of the sheet 100 facing the forming mold cavity 11 is plastically deformed, and finally forms the target component by mold sticking. In this process, the vertical pressing force of (P0·S2+P1·S3)cos α is applied to the edge of the sheet 100 by the blank holder ring 2; and the thickness side wall bears the force of P1·S1 to realize feeding.

Specifically, referring to FIG. 1 and FIG. 2, in the embodiment, according to a command of a power system, the fast-flying rigid impactor 8 impacts the liquid medium, thereby generating a pulse high pressure in it. Then, pulse high-pressure forming is performed on the sheet 100. The forming process can be subdivided into the following three parts:

(1) The first part is the action of a high-pressure load. The process is as follows: the working sleeve assembly and the lower concave mold 1 remain motionless after die assembly. Then the power system (stamping device) of equipment for hydroforming by liquid filling impact starts charging energy. After reaching a set value, it is released. The energy acts on the rigid impactor 8. The rigid impactor 8 obtains a very high speed under the action of the released energy, and quickly hits the surface of the liquid medium to generate a pulse high pressure. The pulse high pressure propagates to the sheet 100 along the liquid medium and makes the sheet 100 plastically deformed.

(2) The second part is the action of hydraulic blank holder. The process is as follows: the liquid medium fills the sheet 100 and the cavity of the concave mold (i.e. the forming mold cavity 11) due to regulation of flow control devices (i.e. the first flow control structure 33 and the second flow control structure 22 mentioned above, the same below) and a shunt device (i.e. the throttling flow channel 4 mentioned above); and the liquid generates normal hydraulic force on the inclined plane (F1 in FIG. 4). The hydraulic force generated in a vertically downward way is F1 cos α. The sheet 100 bears a thickness direction feeding pressure and vertical component force of the normal pressure of the inclined plane of the shunt device, but does not bear the upward liquid pressure at the bottom. Therefore, according to stress analysis, it can be seen that the sheet 100 bears resultant force in the vertical direction of F1; and the direction is downward. At this time, liquid-solid-solid transfer can be realized to complete blank holder, as shown in FIG. 2.

(3) The third part is the action of supply and feeding. The process is as follows: due to the continuous action of liquid medium, the sheet 100 continues to deform under the action of pulse high pressure; and the concave mold cavity is gradually filled. A feeding pressure generated by the high-pressure liquid load on the vertical wall at the outer edge of the sheet 100 is F3=P*S3−μF1 cos α, which further pushes the edge of the sheet 100 to concentrate towards the middle to complete the feeding.

In this way, after the forming is finished, the mold is opened; and the target component is taken out.

According to an embodiment of the present disclosure, an impact hydroforming method of a sheet is further provided, which is carried out by adopting the impact hydroforming mold shown in FIG. 3, and includes the following steps of:
fixing the lower concave mold 1 on a base 7;
sleeving the positioning ring 6 on the positioning convex ring 12;
placing the sheet 100 on the positioning ring 6 and covering the cavity opening of the forming mold cavity 11;
placing the blank holder ring 2 on the side of the sheet 100 far from the lower concave mold 1;
assembling the working sleeve assembly on the lower concave mold 1;
filling the liquid medium into the liquid chamber 31; and
controlling the rigid impactor 8 to descend to impact the liquid medium at a preset pressure.

Specifically, referring to FIG. 3 and FIG. 4, in the embodiment, according to a command of a power system, the fast-flying rigid impactor 8 impacts the liquid medium, thereby generating a pulse high pressure in it. Then, pulse high-pressure forming is performed on the sheet 100. The forming process can be subdivided into the following three parts:

(1) The first part is the action of a high-pressure load. The process is as follows: the working sleeve assembly and the lower concave mold 1 remain motionless after die assembly. Then the power system of equipment for hydroforming by liquid filling impact starts charging energy. After reaching a set value, it is released. The energy acts on the rigid impactor 8. The rigid impactor 8 obtains a very high speed under the action of the released energy, and quickly hits the surface of the liquid medium to generate a pulse high pressure. The hydraulic force is set to F1. The pulse high pressure propagates to the sheet 100 along the liquid medium and makes the sheet 100 plastically deformed.

(2) The second part is the action of hydraulic blank holder. The process is as follows: the liquid medium fills the sheet and the cavity of the concave mold due to regulation of flow control devices and a shunt device; and the liquid generates normal hydraulic force F1 on the inclined plane. The hydraulic force generated in a vertically downward way is F1 cos α. The liquid 7 generates upward hydraulic force F2 on the positioning ring 9. When F1 cos α<F2, according to stress analysis, it can be seen that the sheet bears resultant force in the vertical direction; and the direction is upward by virtue of a transition round corner of the lower concave mold 1. At this time, liquid-solid-solid transfer can be realized to complete blank holder, which is further beneficial to sheet forming, as shown in FIG. 4.

(3) The third part is the action of supply and feeding. The process is as follows: due to the continuous action of liquid medium, the sheet 100 continues to deform under the action of pulse high pressure; and the concave mold cavity is gradually filled. A feeding pressure generated by the high-pressure liquid load on the vertical wall at the outer edge of the sheet 100 is F3=P*S3−μ(F1 cos α+F2), which further pushes the edge of the sheet 100 to concentrate towards the middle to complete the feeding.

In this way, after the forming is finished, the mold is opened; and the target component is taken out.

Those skilled in the art can easily understand that the advantageous technical features of the above modes can be freely combined and superimposed without conflict.

The above is only the preferred embodiment of the present disclosure, and it is not used to limit the present disclosure. Any modification, equivalent substitution and improvement made within the spirit and principle of the present disclosure should be included in the protection scope of the present disclosure. The above is only the preferred implementation of the present disclosure. It should be pointed out that for those ordinarily skilled in the art, several improvements and variations can be made without departing from the technical principles of the present disclosure, and these improvements and variations should also be regarded as the protection scope of the present disclosure.

1. An impact hydroforming mold with integration of blank holder and feeding, comprising:
a lower concave mold (1), which is provided with a forming mold cavity (11), wherein the shape of the forming mold cavity (11) is matched with the shape of a target component;
a blank holder ring (2), which is placed on a sheet (100) to form pressing on the sheet (100) during a forming operation of the mold, wherein the blank holder ring (2) is provided with a central hole (21) corresponding to the position of a cavity opening of the forming mold cavity (11);
a working sleeve assembly, which is sleeved on the radial outer side of the blank holder ring (2) and is hermetically connected to a first end face of the lower concave mold (1), wherein the working sleeve assembly comprises a working sleeve (3);
the working sleeve (3) has a liquid chamber (31) for containing a liquid medium and a stamping acceleration channel (32) for guiding linear movement of a rigid impactor (8);
a throttling flow channel (4) is formed between one end of the working sleeve (3) facing the lower concave mold (1), and one end of the blank holder ring (2) facing the working sleeve (3); and
the liquid medium in the liquid chamber (31) can be throttled and depressurized through the throttling flow channel (4) and then contacted with a thickness side face of the sheet (100).

2. The impact hydroforming mold according to claim 1, wherein the end of the working sleeve (3) facing the lower concave mold (1) is a first conical face;
the end of the blank holder ring (2) facing the working sleeve (3) is a second conical face; and
a taper of the first conical face is equal to that of the second conical face.

3. The impact hydroforming mold according to claim 2, wherein the first conical face is provided with a first flow control structure (33) extending along a circumferential direction;
the second conical face is provided with a second flow control structure (22) extending along a circumferential direction; and
the first flow control structure (33) and the second flow control structure (22) are relatively spaced apart to form a throttling annular gap for the liquid medium.

4. The impact hydroforming mold according to claim 3, wherein on the axial section of the working sleeve (3), the cross-sectional shapes of the first flow control structure (33) and the second flow control structure (22) are semicircular.

5. The impact hydroforming mold according to claim 1, wherein the working sleeve assembly further comprises a fixed sleeve (5) which is hermetically sleeved on the end of the working sleeve (3) facing the lower concave mold (1); and
the working sleeve assembly is hermetically connected to the lower concave mold (1) by means of the fixed sleeve (5).

6. The impact hydroforming mold according to claim 3, wherein a positioning convex ring (12) protruding towards one side of the working sleeve (3) is formed at a cavity opening of the forming mold cavity (11);
the positioning convex ring (12) is sleeved with a positioning ring (6);
floating space is formed between the positioning ring (6) and the first end face; and
the liquid medium in the liquid chamber (31) can enter the floating space through the throttling flow channel (4).

7. The impact hydroforming mold according to claim 6, wherein friction coefficients of the blank holder ring (2) and the positioning ring (6) are the same as u;
during a mold forming operation, the surface area of the thickness side face of the sheet (100) is S1;
the intensity of pressure of the liquid medium in the liquid chamber (31) is P0;
the intensity of pressure of the liquid medium throttled through the throttling flow channel (4) is P1;
the surface area of the second conical face at the side of the second flow control structure (22) close to the liquid chamber (31) is S2;
the surface area at the side of the second flow control structure (22) far from the liquid chamber (31) is S3;
a taper angle of the second conical face is α;
the surface area of the side of the positioning ring (6) facing away from the blank holder ring (2) is S4; and
P1·S1−μ((P0·S2+P1·S3)cos α+P1·S4)>0, and P1<P0.

8. The impact hydroforming mold according to claim 3, wherein the friction coefficient of the blank holder ring (2) is μ;
during a mold forming operation, the surface area of the thickness side face of the sheet (100) is S1;
the intensity of pressure of the liquid medium in the liquid chamber (31) is P0;
the intensity of pressure of the liquid medium throttled through the throttling flow channel (4) is P1; the surface area of the second conical face at the side of the second flow control structure (22) close to the liquid chamber (31) is S2;
the surface area at the side of the second flow control structure (22) far from the liquid chamber (31) is S3;
a taper angle of the second conical face is α; and
P1·S1−μ(P0·S2+P1·S3)cos α>0, and P1<P0.

9. An impact hydroforming method of a sheet, which is carried out by adopting the impact hydroforming mold with integration of blank holder and feeding according to claim 1, comprising the following steps of:
fixing the lower concave mold (1) on a base (7);
placing the sheet (100) on the lower concave mold (1) and covering the cavity opening of the forming mold cavity (11);
placing the blank holder ring (2) on the side of the sheet (100) far from the lower concave mold (1);
assembling the working sleeve assembly on the lower concave mold (1);
filling the liquid medium into the liquid chamber (31); and
controlling the rigid impactor (8) to descend to impact the liquid medium at a preset pressure.

10. An impact hydroforming method of a sheet, which is carried out by adopting the impact hydroforming mold according to claim 6, comprising the following steps of:
fixing the lower concave mold (1) on a base (7);
sleeving the positioning ring (6) on the positioning convex ring (12);
placing the sheet (100) on the positioning ring (6) and covering the cavity opening of the forming mold cavity (11);
placing the blank holder ring (2) on the side of the sheet (100) far from the lower concave mold (1);
assembling the working sleeve assembly on the lower concave mold (1);
filling the liquid medium into the liquid chamber (31); and
controlling the rigid impactor (8) to descend to impact the liquid medium at a preset pressure.

11. The impact hydroforming method of a sheet, which is carried out by adopting the impact hydroforming mold with integration of blank holder and feeding according to claim 9, wherein the end of the working sleeve (3) facing the lower concave mold (1) is a first conical face; the end of the blank holder ring (2) facing the working sleeve (3) is a second conical face; and a taper of the first conical face is equal to that of the second conical face.

12. The impact hydroforming method of a sheet, which is carried out by adopting the impact hydroforming mold with integration of blank holder and feeding according to claim 11, wherein the first conical face is provided with a first flow control structure (33) extending along a circumferential direction; the second conical face is provided with a second flow control structure (22) extending along a circumferential direction; and the first flow control structure (33) and the second flow control structure (22) are relatively spaced apart to form a throttling annular gap for the liquid medium.

13. The impact hydroforming method of a sheet, which is carried out by adopting the impact hydroforming mold with integration of blank holder and feeding according to claim 12, wherein on the axial section of the working sleeve (3), the cross-sectional shapes of the first flow control structure (33) and the second flow control structure (22) are semicircular.

14. The impact hydroforming method of a sheet, which is carried out by adopting the impact hydroforming mold with integration of blank holder and feeding according to claim 9, wherein the working sleeve assembly further comprises a fixed sleeve (5) which is hermetically sleeved on the end of the working sleeve (3) facing the lower concave mold (1); and
the working sleeve assembly is hermetically connected to the lower concave mold (1) by means of the fixed sleeve (5).

15. The impact hydroforming method of a sheet, which is carried out by adopting the impact hydroforming mold with integration of blank holder and feeding according to claim 12, wherein the friction coefficient of the blank holder ring (2) is μ;
during a mold forming operation, the surface area of the thickness side face of the sheet (100) is S1;
the intensity of pressure of the liquid medium in the liquid chamber (31) is P0; the intensity of pressure of the liquid medium throttled through the throttling flow channel (4) is P1;
the surface area of the second conical face at the side of the second flow control structure (22) close to the liquid chamber (31) is S2;
the surface area at the side of the second flow control structure (22) far from the liquid chamber (31) is S3;
a taper angle of the second conical face is α; and
P1·S1−μ(P0·S2+P1·S3)cos α>0, and P1<P0.

16. The impact hydroforming method of a sheet, which is carried out by adopting the impact hydroforming mold according to claim 10, wherein friction coefficients of the blank holder ring (2) and the positioning ring (6) are the same as μ;
during a mold forming operation, the surface area of the thickness side face of the sheet (100) is S1;
the intensity of pressure of the liquid medium in the liquid chamber (31) is P0;
the intensity of pressure of the liquid medium throttled through the throttling flow channel (4) is P1;
the surface area of the second conical face at the side of the second flow control structure (22) close to the liquid chamber (31) is S2;
the surface area at the side of the second flow control structure (22) far from the liquid chamber (31) is S3;
a taper angle of the second conical face is α;
the surface area of the side of the positioning ring (6) facing away from the blank holder ring (2) is S4; and
P1·S1−μ((P0·S2+P1·S3)cos α+P1·S4)>0, and P1<P0.
